(19) United States
(12) Patent Application Publication
(10) Pub. No.: US 2025/0104389 A1
(43) Pub. Date: Mar. 27, 2025

(54) METHOD AND DEVICE FOR CHARACTERIZING AN OBJECT FOR AUTHENTICATION

(71) Applicant: TRINAMIX GMBH, Ludwigshafen Am Rhein (DE)

(72) Inventors: Christian LENNARTZ, Ludwigshafen am Rhein (DE); Vera Charlotte KOCKLER, Ludwigshafen am Rhein (DE); Sharat RAVI SHANKAR, Ludwigshafen am Rhein (DE); Jonas GROSSE HOLTHAUS, Bergisch Gladbach (DE); Christian HESS, Ludwigshafen am Rhein (DE); Friedrich SCHICK, Muenchen (DE)

(21) Appl. No.: 18/833,032

(22) PCT Filed: Feb. 15, 2023
(86) PCT No.: PCT/EP23/53765

§ 371 Date: Jul. 25, 2024

(30) Foreign Application Priority Data
Feb. 15, 2022 (EP) 22156774.6

(51) Int. Cl. G06V 10/60; G06V 10/141; G06V 10/44; G06V 10/82; G06V 20/00; G06V 20/52

(52) U.S. Cl. CPC G06V 10/60; G06V 10/141; G06V 10/44; G06V 10/82; G06V 20/52; G06V 20/95

(57) ABSTRACT

Disclosed herein is a method for characterizing material properties of an object, where the object has a form and including at least one material, the method includes receiving imaging data associated to the object, determining, by processing the received imaging data, at least one reflection feature corresponding to a spot in the first image: comparing, by processing the at least one reflection feature, the spot pattern comprised in the first image with reference spot patterns for obtaining a comparison result; and determining a material property of the object as a function of the comparison result. Further disclosed herein is a device with data processing capabilities and for implementing the method.

This disclosure relates to methods, devices and computer programs for characterizing objects to be authenticated. In particular, electronic devices having data processing, imaging and displaying features are suitable for use as authentication devices as disclosed herein.

It is sometimes necessary to check the origin or originality of objects, such as products, documents or goods. Conventionally, authenticity checks are made manually, for example by manual inspection of specific objects or items. In some cases, objects have a safety or security feature that can be used for authenticating the respective objects or items. Those security features, such as holographic representations, require specific hardware to validate as authentic.

It is an object of the present disclosure to provide reliable and efficient means for checking or determining if an object to be authenticated is genuine.

According to one aspect of this disclosure, a method for characterizing material properties of an object, in particular of an object to be authenticated, is presented. Said object has a form and comprises at least one material, and the method comprises the steps of:
receiving imaging data associated to the object, said imaging data being obtained by the process of irradiating at least one illumination pattern comprising a plurality of illumination features onto the object, and receiving at least one first image comprising a spot pattern originating from the object in response to the irradiated illumination pattern;
determining, by processing the received imaging data, at least one reflection feature corresponding to a spot in the first image, wherein said reflection feature may have an associated beam profile;
comparing, by processing the at least one reflection feature, the spot pattern comprised in the first image with reference spot patterns for obtaining a comparison result; and
determining a material property of the object as a function of the comparison result.

In embodiments, the method is a computer-implemented method.

According to another aspect, a device for characterizing material properties of an object, in particular a display device, is presented, comprising:
a light source configured to generate at least one illumination pattern comprising a plurality of illumination features;
an optical sensor unit configured to capture at least one first image comprising a spot pattern originating from an object and to generate imaging data associated with the object;
at least one processing unit configured,
   to receive the imaging data,
   to determine, by processing the received imaging data, at least one reflection feature corresponding to a spot in the first image, wherein said reflection feature may have an associated beam profile,
   to compare, by processing the at least one reflection feature, the spot pattern comprised in the first image with reference spot patterns for obtaining a comparison result, and
   to determine a material property of the object as a function of the comparison result; and
an output unit configured to output the comparison result and/or the determined material property.

The method and the device, in particular implemented as a display device, may be used to authenticate an object to be authenticated by determining at least one material property of the object from imaging data associated to the object. The determined material property of the object can be considered indicative of an authenticity of the object, e.g. taking into account the form of the object or input data received from a user. For example, if the input data is consistent with the detected material property, the object may be validated as being authentic or original.

In embodiments, the object is a product, in particular a tangible product. Further, the product is a manufactured product, for example. Preferably, the object is a non-living object.

It is understood that the presented display device may include a processing unit, that is configured to cause the components in the device to cooperatively carry out any one of the method steps of the method for characterizing material properties of an object disclosed herein with respect to further aspects or embodiments of the method.

It is an advantage of the disclosed method and device that material properties of objects to be authenticated are taken into account without a manual or invasive probing of the object. The method and devices provide for reliable authentication, for example using hand-held devices, such as mobile display devices, smartphones or tablet computers. This allows to detect counterfeited products or materials based on acquired imaging data.

In embodiments, the method further comprises the step of generating the imaging data, wherein generating comprises:
irradiating at least one illumination pattern comprising a plurality of illumination features onto the object, in particular using coherent light from a monochromatic light source; and
receiving at least one first image comprising a spot pattern originating from the object in response to the irradiated illumination pattern at an optical sensor device.

Suitable illumination patterns and light sources for generating the imaging data are, for example, disclosed in WO 2020/187719 A1 which is herewith incorporated by reference. Specifically, page 44/line 17 through page 47/line 16 of WO 2020/187719 A1 discloses aspects for generating and analyzing reflection features of objects illuminated with structured illumination patterns. The illumination patterns and determined reflection features therein can be used in the methods and devices of this disclosure.

Each of the reflection features may comprise at least one beam profile. As used herein, the term “beam profile” of the reflection feature may generally refer to at least one intensity distribution of the reflection feature, such as of a light spot in the image. The beam profile may be selected from the group consisting of a trapezoid beam profile; a triangle beam profile; a conical beam profile and a linear combination of Gaussian beam profiles.

As used herein, the term “material property” refers to at least one arbitrary property of the material configured for characterizing and/or identification and/or classification of the material. For example, the material property may be a property selected from the group consisting of: rough-ness, penetration depth of light into the material, a property characterizing the material as bio-logical or non-biological material, a reflectivity, a specular reflectivity, a diffuse reflectivity, a sur-face property, a measure for translucence, a scattering, specifically a back-scattering behavior or the like. The at least one material property may be a property selected from the group consisting of: a scattering coefficient, a translucency, a transparency, a deviation from a Lambertian surface reflection, a speckle, and the like. As used herein, the term “characterizing at least one material property of an object” refers to one or more of determining and assigning the material property to the object. In embodiments, “material property” means a material composition of the object in terms of its material.

The device for characterizing material properties of an object to be authenticated can be implemented as a display device, in particular, a display device having a translucent display unit. Using a translucent display has the advantage of covering the illumination source and the optical sensor unit thereby rendering the device easier to clean and protecting the light source and sensor unit.

In embodiments, the reflection features are not due to a surface roughness. Thus, in embodiments, one may exclude the influence of a surface roughness to the processed reflection feature,

In embodiments, the method then further comprises:
irradiating the at least one illumination pattern through a translucent display unit; and/or
passing the at least one first image comprising the spot pattern through said translucent display unit prior to the step of receiving the at least first image at the optical sensor unit.

In embodiments, the process of obtaining the imaging data associated to the object to be authenticated further comprises the steps of irradiating illumination light onto the object and receiving reflected light from the object for obtaining a second image of the object.

The illumination light may be flat light, generated by a flood-light projector device, essentially homogeneously illuminating the object, thus allowing to capture a second (two-dimensional) image in terms of the imaging data.

Capturing a first image and a second image comprising different features renders the detection of a material property of the object even more reliable.

In embodiments, the first and/or second image is deployed to determine a contour of the object. One may contemplate a step of recognizing a contour and/or edges of the object as a function of the first and/or second image, in particular, based on reference images of the object to be characterized.

In embodiments, the method comprises at least one of the steps of:
generating or capturing an image of the object for obtaining (in particular further) image data
receiving an image and (or image data associated to the object; and/or determining or recognizing a contour of the object.

The image may be the first and/or second image as depicted above or below. Consequently, embodiments comprise the step of determining a material property of the object as a function of the comparison result and the contour of the object. Thus, determining a property of the object or characterizing the object may comprise assessing the contour of the object.

In embodiments, determining a contour includes:
generating contour image features from the image data;
comparing the contour image features with reference image features generated from reference objects and/or
recognizing a contour of the object as a function of the comparison.

The embodiment may include: generating reference image features corresponding to images captured from reference objects.

Consequently, the first image can include spots having an increased brightness or luminosity, and the second image may include a two-dimensional image of the object.

In embodiments of the method for characterizing material properties, the step of determining then includes:
identifying or extracting at least one patch, area, region or footprint of the associated beam profile of the first image, including at least one spot having highest brightness among the spots; and
generating for said identified or extracted spot at least one vector or array.

The step of comparing may then include:
comparing the generated at least one feature vector with a plurality of predetermined feature vectors being representative for a material property of the object.

The first image may stem from reflected laser light realizing the illumination pattern with illumination features. This may involve surface and volume or bulk backscattering at or from the object. Investigations of the applicant have shown that considering the brightest spots in the first image can be considered sufficiently reliable for deriving the material properties of the object.

In WO 2021/105265 A1, which is hereby included by reference, methods and aspects of evaluation devices for determining beam profiles of reflection features and deriving material properties from feature vectors are disclosed. The steps of identifying or extracting the patches where spots having the highest brightness are located, and generating respective feature vectors may involve a neural network that is trained accordingly. Training the neural network can involve aspects for identifying brightest spots according to WO 2021/105265 A1.

It is understood that the material features disclosed and explained in WO 2020/187719, WO 2021/105265 and WO2018/091649, all of which are incorporated by reference, can be deployed as feature vectors used in the herewith disclosed methods and devices.

In embodiments, the step of comparing the at least one feature vector with reference feature vectors may include deploying a machine-learned classifier, in particular an artificial neural network.

Reference feature vectors may be predetermined by carrying out the method steps for obtaining imaging data associated to reference objects.

In particular, the method may comprise:
for a plurality of material objects, generating at least one reference feature vector for each material object; and
classifying the generated at least one reference feature vector into a material and/or an object category.

The material objects can be considered reference material objects having a known material characteristic. Thus, categorizing or classifying reference feature vectors leads to a collection of reference data that can be used in comparing the feature vectors from the object to be authenticated. For example, if a generated feature vector corresponding to the object to be authenticated is same or similar to one of the reference feature vectors, the method or device determines that the material property of the object to be authenticated corresponds to the material property of the reference object corresponding to the reference vector. In embodiments, reference objects have a predetermined shape and/or contour.

The method in embodiments may further include the process of training a machine-learning classifier based on the generated and classified plurality of reference vectors.

In further embodiments of the method, the steps of detecting by processing the imaging data, includes:
detecting a security marker at the object, said security marker being indicative of an authenticity or origin of the object; and
generating an authenticity signal for the object as a function of the determined material property and/or information derived from the security marker are carried out.

In yet other embodiments of the method, the steps of detecting by processing the imaging data, includes:
recognizing a contour of the object; and
generating an authenticity signal for the object as a function of the determined material property and/or the recognized contour are carried out.

Sometimes, objects or items have a security marker as a safety feature. This disclosure allows to use material properties of security markers as a further safety feature. Conventionally, security markers contain computer-readable information, for example about the object or item that has the security marker attached to. For example, a pattern recognition algorithm implemented by a processing unit may derive information from the security marker. Taking into account information derived from the security marker together with the determined material property of the object to be authenticated renders an authentication process more reliable. For example, the authenticity signal indicates as to whether the object to be authenticated can be considered authentic or not.

According to another aspect of this disclosure a security marker is presented, said security marker having a predetermined material property, e.g. a material composition, that can be determined by any one of the method aspects for characterizing a material property in this disclosure.

According to another aspect of this disclosure a use of a security marker attached to an object as a security feature.

Embodiments of aspects disclosed herein may comprise: attaching a security marker having a pre-determined material property to an object to be authenticated.

In further embodiments of the method, the method comprises at least one of the steps of:
displaying a visual image of the object on a display unit in the display device using the imaging data;
overlaying the visual image with a bounding box indicating the detected security marker at the object; and
generating a validation signal perceivable for a user, if an authenticity signal is generated.

Displaying a visual image of the object to be authenticated may render the use of an authentication device or device for characterizing material properties of the object to be authenticated easier. Using pattern recognition, the visual image of the object to be authenticated and the position of the security marker, in particular in the two-dimensional second image of the object, makes it easy to position or direct the optical sensor unit towards the object.

A validation signal is, for example, an audible, tactile or visual signal that is perceivable for a user. In particular, if a front side camera of a hand-held device is used as an imaging unit with an optical sensor unit, the user cannot see the display. It is thus an advantage if there is a validation signal independent from the displayed content. For example, a validation signal is a vibration, a tone or light signal perceivable at or from the backside of the respective hand-held device.

In some embodiments of the display device, the display device comprises a secure enclave configured to carry out the processes of comparing the spot pattern comprised in the first image with reference spot patterns for obtaining a comparison result and of determining the material property of the object as a function of the comparison result.

In particular, processes involving pre-classified reference feature vectors should be protected from unauthorized access and may thus be performed within secure enclaves.

A secure enclave may be a secure enclave processor implemented as a system-on-chip that performs security services for other components in the device and that securely communicates with other subsystems in device, e.g. the processing unit. A secure enclave processor may include one or more processors, a secure boot ROM, one or more security peripherals, and/or other components. The security peripherals may be hardware-configured to assist in the secure services performed by secure enclave processor. For example, the security peripherals may include: authentication hardware implementing various authentication techniques, encryption hardware configured to perform encryption, secure-interface controllers configured to communicate over the secure interface to other components, and/or other components. In some embodiments, instructions executable by secure enclave processor are stored in a trust zone in memory subsystem that is assigned to secure enclave processor. The secure enclave processor fetches the instructions from the trust zone for execution. In general. secure enclave processor may be isolated from the rest of processing subsystems except for a carefully controlled interface, thus forming a secure enclave for the secure enclave processor and its components.

According to yet another aspect, a use of the device for characterizing a material property, in particular implemented as a display device according to the aspects above and/or embodiments disclosed below, the use of a device for authenticating an object, the object being one of the group of a branded product, a luxury item, a bank note, a package, a document, a passport, an identity card, a spare part, a food container, is presented. In particular, the before mentioned objects to be authenticated have a visible or invisible marker or patch attached.

In embodiments, a computer-program or computer-program product comprises a program code for executing the above-described methods and functions by a computerized control device when run on at least one control computer, in particular when run on the display device. A computer program product, such as a computer program means, may be embodied as a memory card, USB stick, CD-ROM, DVD or as a file which may be downloaded from a server in a network. For example, such a file may be provided by transferring the file comprising the computer program product from a wireless communication network.

In a further aspect, the display device is a smartphone or a tablet computer having a translucent screen as the display unit. In this aspect, the imaging unit is for example a front camera. The imaging unit can be located on an interior of the display device, behind the translucent screen. The imaging unit can include the optical sensor unit and an illumination source for emitting light through the translucent screen to illuminate the object. The optical sensor unit receives light from the object and passing through the translucent screen. The optical sensor unit may general a sensor signal in a manner dependent on an illumination of a sensor region or light sensitive area of the optical sensor. The sensor signal may be passed onto the processing unit to reconstruct an image of the object captured by the camera and/or to process the image, in particular, along the lines defined above and below with respect to embodiments of the method disclosed.

As used herein, the term “optical sensor unit” generally refers to a device or a combination of a plurality of devices configured for sensing at least one optical parameter. The optical sensor unit may be formed as a unitary, single device or as a combination of several devices. In embodiments, the optical sensor unit comprises a matrix of optical sensors. The optical sensor unit may comprise at least one CMOS sensor. The matrix may be composed of independent pixels such as of independent optical sensors. Thus, a matrix of inorganic photodiodes may be composed. Alternatively, however, a commercially available matrix may be used, such as one or more of a CCD detector, such as a CCD detector chip, and/or a CMOS detector, such as a CMOS detector chip. Thus, generally, the optical sensor unit may be and/or may comprise at least one CCD and/or CMOS device and/or the optical sensors may form a sensor array or may be part of a sensor array, such as the above-mentioned matrix. As an example, the sensor element may be part of or constitute at least one CCD and/or CMOS device having a matrix of pixels, each pixel forming a light-sensitive area.

As used herein, an “optical sensor” generally refers to a light-sensitive device for detecting a light beam, such as for detecting an illumination and/or a light spot generated by at least one light beam. As further used herein, a “light-sensitive area” generally refers to an area of the optical sensor which may be illuminated externally, by the at least one light beam, in response to which illumination at least one sensor signal is generated. The sensor signals are electronically processed and result in sensor data. The plurality of sensor data relating to the capture the light reflected by an object may be referred to as imaging data associated to the object.

Further possible implementations or alternative solutions of the invention also encompass combinations—that are not explicitly mentioned herein—of features described above or below in regard to the embodiments. The person skilled in the art may also add individual or isolated aspects and features to the most basic form of the invention.

Further embodiments, features and advantages of the present invention will become apparent from the subsequent description and dependent claims, taken in conjunction with the accompanying drawings, in which:

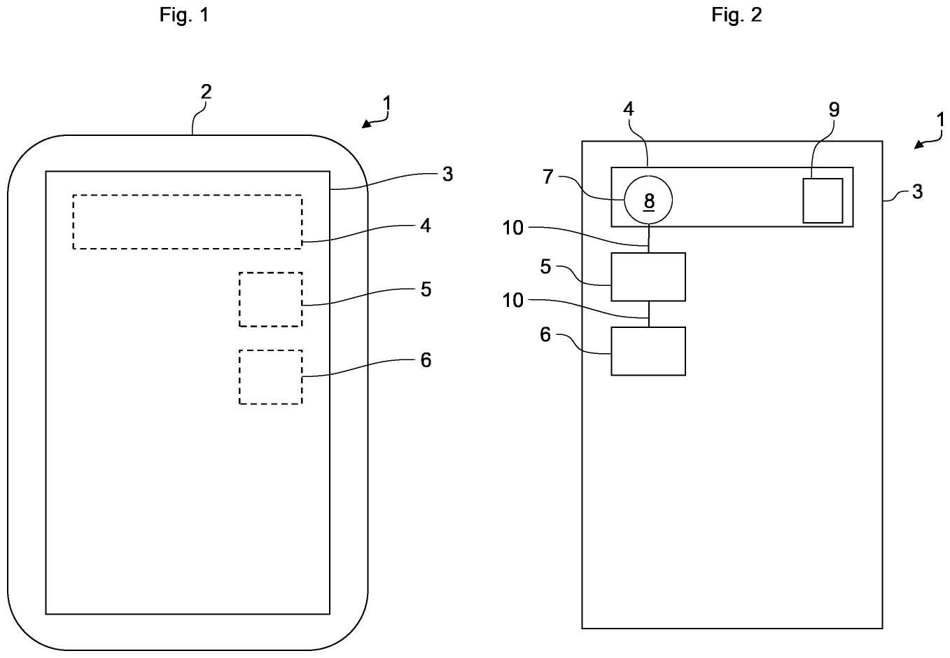

FIG. 1 shows a display device according to a first embodiment;

FIG. 2 shows components of the display device of FIG. 1;

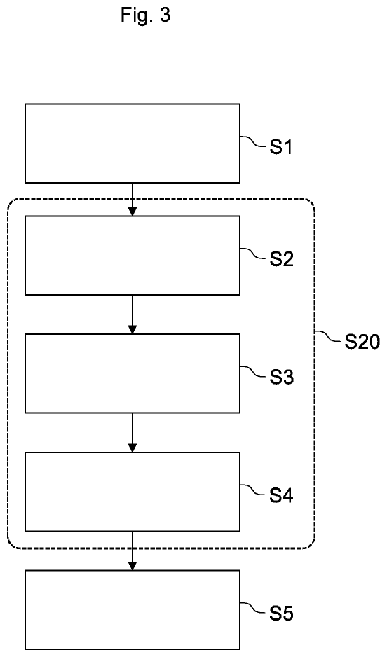

FIG. 3 shows method steps involved in method for characterizing material properties of an object according to a first embodiment;

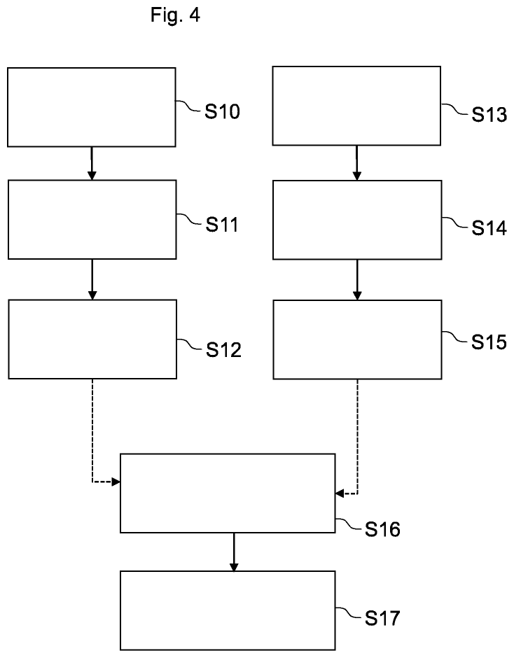

FIG. 4 shows method steps involved in a process for acquiring imaging data for embodiments of the method for characterizing material properties of an object;

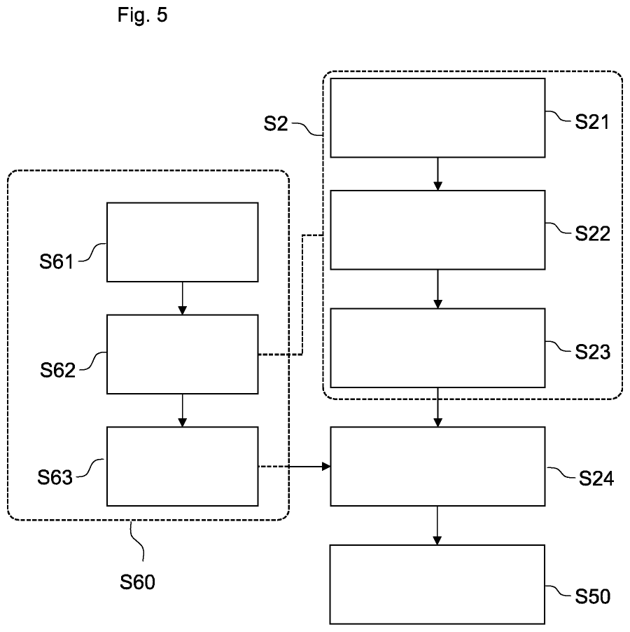

FIG. 5 shows method steps involved in embodiments for processes or generating pluralities of reference vectors and for generating an authenticity signal;

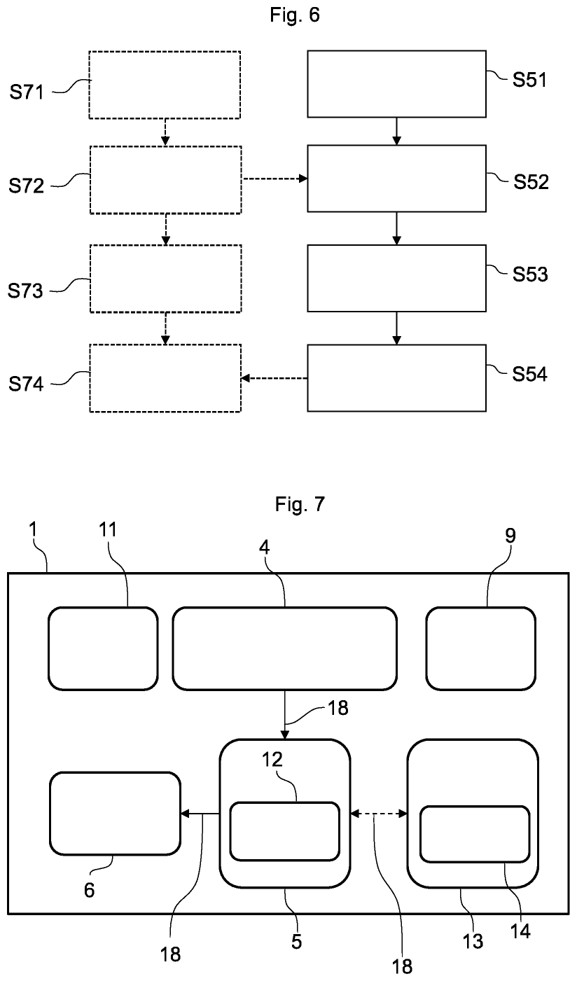

FIG. 6 shows method steps involved in embodiments for authentication processes using security markers at objects; and

FIG. 7 shows a display device according to a second embodiment.

In the Figures, like reference numerals designate like or functionally equivalent elements, unless otherwise indicated.

FIG. 1 shows a display device 1 according to a first embodiment. The display device 1 is a smartphone and includes a translucent touchscreen 3 as a display unit. The display unit 3 is configured for displaying information. Such information can include a text, image, diagram, video, or the like. Besides the display unit 3, the display device 1 includes an imaging unit 4, a processing unit 5 and an output unit 6. In FIG. 1, the imaging unit 4, the processing unit 5 and the output unit 6 are represented by dashed squares because they are located within a housing 2 of the display device 1, and behind the display unit 3 when viewed from an exterior of the display device 1.

FIG. 2 shows the components of the display device 1 located on the interior of the housing 2 in more detail. FIG. 2 corresponds to a view onto the display unit 3 from an interior of the display device 1, with the imaging unit 4, the processing unit 5 and the output unit 6 being located in front of the display unit 3.

The imaging unit 4 is a front camera. The imaging unit 4 is configured to capture an image of surroundings of the display device 1. In detail, an image of a scene in front of the display unit 3 of the display device 1 can be captured using the imaging unit 4. The surroundings are here defined as a half-sphere located in front of the imaging unit 4 and centered around a center of the display. The radius of the half-sphere is, for example, 5 m.

The imaging unit 4 includes an illumination source 9 and an optical sensor unit 7 having a light sensitive area 8. The illumination source 9 is an infrared (IR) laser point projector realized by a vertical-cavity surface-emitting laser (VCSEL). The IR light emitted by the illumination source 9 shines through the translucent display unit 3 and generates multiple laser points on the scene surrounding the display device 1. When an object, such as a person, is located in front of the display device 1 (in the surroundings of the display device 1, facing the display unit 3 and the imaging unit 2), an image of the object is reflected towards the imaging unit 4. This reflected image also includes reflections of the laser points.

Instead of the illumination source 9 being an IR laser pointer, it may be realized as any illumination source capable of generating at least one illumination light beam for fully or partially illuminating the object in the surroundings. For example, other spectral ranges are feasible. The illumination source may be configured for emitting modulated or non-modulated light. In case a plurality of illumination sources is used, the different illumination sources may have different modulation frequencies. The illumination source may be adapted to generate and/or to project a cloud of points, for example the illumination source may comprise one or more of at least one digital light processing (DLP) projector, at least one Liquid crystal on silicon (LCoS) projector, at least one spatial light modulator, at least one diffractive optical element, at least one array of light emitting diodes, at least one array of laser light sources.

The optical sensor 7 is here realized as a complementary metal-oxide-semiconductor (CMOS) camera. The optical sensor unit 7 looks through the display unit 3. In other words, it receives the reflection of the object through the display unit 3. The image reflected by the object, such as the person, is captured by the light sensitive area 8. When light from the reflected image reaches the light sensitive area 8, a sensor signal indicating an illumination of the light sensitive area 8 is generated. Preferably, the light sensitive area 8 is divided into a matrix of multiple sensors, which are each sensitive to light and each generate a signal in response to illumination of the sensor.

Instead of a CMOS camera, the optical sensor 7 can be any type of optical sensor designed to generate at least one sensor signal in a manner dependent on an illumination of the sensor region or light sensitive area 8. The optical sensor 7 may be realized as a charge-coupled device (CCD) sensor.

The signals from the light sensitive area 8 are transmitted to the processing unit 5. The processing unit 5 is configured to process the signals received from the optical sensor 7 (which form an image). By analyzing a shape of the laser spots reflected by the object and captured by the optical sensor 7, the processing unit 5 can determine a distance to the object and a material information of the object. In the example of FIGS. 1 and 2, the imaging unit 4, the processing unit 5 and the output unit 6 are communicatively coupled, e.g. through an internal bus system or connection lines 10.

The display device 1 shown in FIGS. 1 and 2 is configured to perform methods for authenticating objects to be authenticated using imaging data associated to the objects. This can be achieved through an application or “app” loaded into the display device in terms of a computer program with instructions to be executed by the processing unit 5 and other components of the smartphone or display device 1, respectively.

FIG. 3 shows method steps involved in a method for characterizing material properties of an object according to a first embodiment. An object to be authenticated, as, for example, a product having a specific form and made of a specific material, sometimes needs to be authenticated or its origin needs to be verified. One may contemplate of luxury goods carrying a particular brand, cosmetics in particular packages, drugs or medicaments, specific documents as objects to be verified or authenticated.

In step S1, imaging data associated to the object or item to be authenticated is received. For example, the imaging unit 4 provides imaging data obtained by capturing a first image comprising a spot pattern originating from the object. The spot pattern occurs in response to an irradiated illumination pattern wherein the illumination pattern comprises a plurality of illumination features. The processing unit 5 receives the imaging data.

Next, the received imagining data containing a first image with a spot pattern are data processed in step S20. As a result of the data processing, in step S20, processing unit 5 outputs a signal indicating the material property of the object to be authenticated to the output unit 6. The output unit 6 may serve as an interface for using the information about the material property of the object. In embodiments, the output signal that is available at the output unit 6 is a signal indicative of the material property of the object to be authenticated or an authenticity signal indicating as to whether the object is to be considered authentic or original. The output signal may also be a comparison signal containing information about a similarity of the material property of the object with respect to reference materials or material properties.

The processing of the imaging data comprises steps S2, S3 and S4. In step S2, at least one reflection feature corresponding to a spot in the first image is determined. The reflection feature can have an associated beam profile. For example, a plurality of bright spots as a result of structured light impinging on the surface and/or bulk of the object to be authenticated is detected as a first image by the optical sensor unit 7. The structured light may be coherent laser light produced by the infrared (IR) laser point projector 9.

For example, a spot pattern is projected onto the object, and a CMOS camera as imaging unit 4 captures the reflected spot pattern. The intensity distribution of the spots can give rise to specific reflection features that can be representative for a material property of the object such as a material composition or a surface property. Reflection features may, for example, include a ratio of a surface and a volume backscattering, a beam or edge profile, a contrast of laser speckle signals, a ratio of diffusive or direct reflection and the like. By carrying out step S2, a reflection feature is obtained. Material dependent reflection features are known from WO 2020/187719, WO 2021/105265 and WO2018/091649.

In the next step S3, the reflection feature obtained from the imaging data associated to the object to be authenticated is compared with reference reflection features. Hence, in a comparison step S3, the spot pattern comprised in the first image obtained from the object is compared with reference spot patterns to obtain a comparison result. The reference spot patterns or reference reflection features are based on reference data for reference objects or reference material properties of objects. Next, in step S4, a material property of the object is determined as a function of the result of the comparison between the reflection feature and reference reflection features.

A library of reference detection features with a mapping to material properties can be used, for example a reference library or database can contain a specific reference reflection feature or reference spot pattern that is associated with a specific material, for example a precious metal. If the reflection feature determined in step S2 compared with a reference reflection feature corresponding to a precious metal does not match or is evaluated as dissimilar in the comparing step S3, it is determined in step S4 that the object cannot be authenticated as comprising a precious metal.

Next, FIG. 4 shows method steps involved in the process of acquiring the imaging data according to an embodiment. In particular, the second embodiment of a display device is suitable for implementing the method steps indicated in FIG. 4.

FIG. 7 shows a display device 1 according to the second embodiment. The display device 1 according to the second embodiment is equally configured to perform the method of any one of FIGS. 3 to 6. However, in addition to the IR laser point projector 9 (patterned light projector) of FIGS. 1 and 2, the display device 1 of FIG. 7 further includes a flood light projector 11 for emitting flood light through the display unit 3 towards an object to be authenticated or verified. The components of the display device are communicatively coupled to each other which is indicated by the arrows and dashed line 18.

In FIG. 7, the neural network used for general image processing by the processing unit 5 in step S2 is represented by the reference numeral 12. In FIG. 7, the output unit 6 forms an interface to apps for communication between the processing unit 5 and the apps. As the information relating to authenticating an object is a security issue, processes involving the reference vectors are executed within a secure enclave 13 including a trained neural network 14 implemented as a classifier.

In step S10, a structured light or an illumination pattern is irradiated onto the object to be authenticated. For example, a coherent light source generates an illumination pattern with a plurality of illumination features that impinge onto the object.

At the object, backscattering on the surface and its bulk volume occurs. Consequently, reflected light is received in step S11 by the imaging unit 4. The light originating from the object in response to the irradiated lamination pattern comprises a first image with the spot pattern.

The imaging unit 4 processes the electronic signals from the optical sensor unit (sensor signals) and provides digital imaging data in step S12.

In addition to the first image, in steps S13, S14 and S15, a second two-dimensional image of the object to be authenticated is acquired. To this extent, a flat light projector 11 of display device 1 generates and emits illumination light towards the object to be authenticated in step S13. Hence, illumination light is irradiated onto the object.

In step S14, the reflected light from the object, in particular visible light, is received by the optical sensor unit 7 within the imaging unit 4. Again, the imaging unit 4 processes the optical sensor unit signals and provides two-dimensional imaging data in step S15.

Hence, processing unit 5 obtains two images, first an image comprising the spot pattern and second a two-dimensional image of the object. Both images are merged in step S16 to imaging data to be analyzed in a further process. The imaging data contains information about the reflection features relating to the spot pattern and two-dimensional image information on the object. In step S17, the imaging data is provided to a neural network 12 used within the processing unit 5. The neural network 12 is implemented to generate feature vectors or feature arrays that relate to the brightest spots within the images of the object.

FIG. 5 shows method steps involved in the processes of determining the material property of the object to be authenticated using reference feature vectors. First, potential sub-steps of step S2, determining at least one reflection feature corresponding to a spot in the first image are explained, wherein the reflection feature may have an associated beam profile.

Step S2 may be divided into steps S21, S22 and S23. In step S21, spots with increased brightness or luminosity relating to the spot pattern of the first image are identified. Methods for identifying the spots are, for example, disclosed in WO 2021/105265 A1.

Once spots or regions with a high brightness are identified in step S21, those are extracted in step S22. For example, patches around brightest spots are extracted. The patches may have a square, rectangular or circular shape and should include at least the footprint of the associated beam profile of the spot under consideration. There can be a plurality of spots having a sufficient brightness to be considered brightest spots. One may contemplate of filtering the image according to predetermined criteria so that only a suitable number of spots are further processed. I embodiments only one brightest spot—a central main spot—is identified, and the respective patch is extracted.

Next, a feature vector for each extracted patch with a brightest spot is generated in step S23. The steps of extracting the brightest spots and generating respective feature vectors in step S23 can be carried out using the neural network that is appropriately configured. The respective feature vector can include data or information relating to the ratio of surface and volume backscattering in the respective spot, a beam profile, a contrast of a laser speckle signal and/or a ratio of diffusive or direct reflection from the object. The feature vector may include aspects as disclosed in WO 2020/187719, which is hereby incorporated by reference.

In particular, a plurality of feature vectors are generated or calculated based on the imaging data of the respective object to be authenticated. In step S24, the feature vectors are compared with a plurality of reference feature vectors that are pre-classified so that a match or high similarity with one of the reference feature vectors indicates a specific material property of the object. This comparison step is done in step S24 and may involve a trained neural network 14 implemented in a secure enclave 13. Comparing the obtained feature vectors referring to the object to be authenticated with the plurality of reference feature vectors in a reference library or database can be implemented by a similarity measure in the feature vector space.

Based on the comparison result, for example, the feature vectors stemming from the imaging data of the images associated to the object to be authenticated correspond to a reference feature vector indicating a material property. An the indicative material property is expected from the object to be authenticated, an authenticity signal is generated in step S50 indicating the originality or authenticity of the object.

Method step S60 indicated in a dashed box refers to providing the plurality of reference vectors. One reference vector, for example, is generated by first selecting a material or object sample in step S61. If specifically branded goods are to be authenticated, for example verified samples of such a luxury good according to a specific brand are selected as a sample object. Next, the sample good is considered an object and is processed under steps S21 through S23, i.e. imaging data is acquired by irradiating an illumination pattern comprising a plurality of illumination features, e.g. by a light source equivalent to the laser light source 9, and the goods are irradiated by flat illumination light, for example by a light source corresponding or equivalent to flat light projector 11. Thus a first and a second image is obtained.

Next, as explained above, reference feature vectors are generated according to step S23 and classified according to the known properties of the item of the luxury good. Because a validated sample of the goods is considered is authentic, in step S63, the respective reference vector is classified into a specific material, object or product category, for example a luxury “leather bag of brand Y” if such is used as a sample. The generated reference vectors are classified as referring to an authentic “leather bag of brand Y”. Similarly, known counterfeited goods or leather bags according to brand Y can be selected as further material samples. The obtained reference vectors are then classified as referring to counterfeited goods.

One may contemplate training a neural network with the classified plurality of reference vectors. The trained neural network 14 can then be used in step S24 to intrinsically compare the feature vector obtained in step S23 to generate an authenticity signal indicating the authenticity of the object or not.

FIG. 6 shows method steps involved in embodiments for authenticating processes that employ security markers at objects.

Security markers can be visible or invisible markers on objects or goods that have specific material properties. Instead of conventional RFID tags, the range of material compositions or material properties is much larger, and therefore provides for unique security markers for objects. A security marker can comprise, for example, a tag or batch with visible and invisible information regarding the object. One can contemplate of a batch having a brand name encoded in visible symbols and contemporaneously in terms of a sequence of stripes, each including a different material. Such a security batch or marker can reliably be detected and classified by the disclosed methods for authenticating objects.

In FIG. 6, steps S51 through S54 illustrate method steps that can be initiated by an app loaded onto the display device 1, for example implemented as a smartphone.

In step S51, an output signal is obtained from the classified neural network 14 indicating a specific material property of an object, for example a leather bag. A leather bag has an attached badge with, for example, a product code and a brand name.

In step S52, processing unit 5 extracts information from the security marker based on the imaging data received. The processing unit 5 may in particular use the imaging data referring to the two-dimensional image of the item, i.e. the leather bag. The security marker in terms of the badge is also comprised and can be read by a pattern recognition algorithm.

Next, in step S53, the obtained material property of the leather bag (e.g. in step S50 shown in FIG. 5) is compared with the information extracted from the security marker. If, for example, the combination of the leather material of the object, the product number or type and the brand matches with each other, for example according to a database, the object can be classified or validated as authentic.

Hence, in step S54, an authenticity signal indicating that the object is either an original or authentic object or a counterfeited object is generated an issued. The authenticity signal can be output through the output unit 6 to the app using the authentication feature of the smartphone 1.

In some embodiments of smartphones, the imaging unit 4 is arranged on the same side as the display which is not specifically indicated in FIG. 7. Hence, the user of the phone directs the display and imaging unit 4 towards the object. He or she thus cannot see any visuals on the display screen.

In FIG. 6, optional method steps to be implemented by the smartphone 1 or display device 1 are shown in dashed boxes. Methods steps S71 through S74 can be carried out by the processing unit 5. In step S71, a security marker is detected within the two-dimensional imaging data of the object. In step S72, the security information, such as the product type or number and brand name is extracted from the imaging data. The extracted security marker information is provided in step S52 as explained above.

Optionally, in step S73, a visual image of the object is displayed on the display unit the display device 1 and, at the same time, a bounding box indicating the position of the detected security marker is overlaid. Thus, the user obtains visual information about the object, e.g. a luxury bag with the highlighted security marker or batch, e.g. by a bounding box.

Additionally or alternatively, a contour of the object is recognized based on a comparison with reference images taken from reference objects. The contour may be displayed as well. The contour can serve as a means to further enhance the reliability of the disclosed methods and systems for characterizing an object, in particular a manufactured product.

Upon generation of the authenticity signal in step S54, the processing unit 5 causes the display device 1 to issue a validation signal. The validation signal is, for example, a tactile signal, an audible signal or a visual signal that the user can perceive having the front side of the display device facing away from him or her. The validation signal can be, for example, a tone, a vibration or a light at the back side of the device 1.

The disclosed methods and devices provide for a simple authentication application implemented, for example, in smartphones. By generating material-dependent feature vectors based on imaging data obtained by illumination and camera facilities of phones, a respective smartphone can be used as an authentication device by loading a respective app onto it. Security-sensitive data relating to the reference feature vectors are preferably stored in a secure enclave processor. Alternatively, or additionally, trained neural network devices can be used as dedicated authentication processors within electronic devices.

Although the present invention has been described in accordance with preferred embodiments, it is obvious for the person skilled in the art that modifications are possible in all embodiments. For example, illumination devices and imaging devices do not need to be arranged in or on the same housing. The sequence of method steps carried out do not need to include all steps mentioned in FIGS. 3-6. It is understood that all the disclosed aspects of methods may relate to computer-implemented methods.

### REFERENCE SIGNS

1 display device
2 housing
3 display unit
4 imaging unit
5 processing unit
6 output unit
7 optical sensor unit
8 light sensitive area
9 light source
10 line
11 flood light projector
12 neural network
13 secure enclave
14 neural network
S1 receiving imaging data
S2 determining reflection features
S3 comparing reflection features with reference reflection features
S4 determining a material property of object
S5 outputting comparison result/material property/authenticity signal
S10 irradiating structured light/illumination pattern on object
S11 receiving spot pattern
S12 providing imaging data with first image
S13 irradiating illumination light on object
S14 receiving reflected light
S15 providing imaging data with second image
S16 merging first and second imaging data
S17 providing imaging data
S20 processing imaging data
S21 identifying spot with increased brightness
S22 extracting imaging data corresponding to brightest spot(s) in first image
S23 generating feature vector
S24 comparing feature vectors with reference vectors
S25 providing plurality of reference feature vectors
S50 generating authenticity signal
S51 receiving output signal
S52 retrieving security marker information
S53 comparing material property and security marker information
S54 generating authenticity signal
S60 providing plurality of reference vectors
S61 selecting material/product sample
S62 generating reference feature vector
S63 classifying reference vector
S71 detecting security marker
S72 extracting security marker information
S73 displaying overlayed visual image and bounding box
S74 generating validation signal

1. A method for characterizing material properties of an object, said object having a form and comprising at least one material, the method comprising the steps of:
receiving imaging data associated to the object, said imaging data being obtained by the process of irradiating at least one illumination pattern comprising a plurality of illumination features onto the object, and receiving at least one first image comprising a spot pattern originating from the object in response to the irradiated illumination pattern;
determining, by processing the received imaging data, at least one reflection feature corresponding to a spot in the first image;
comparing, by processing the at least one reflection feature, the spot pattern comprised in the first image with reference spot patterns for obtaining a comparison result; and
determining a material property of the object as a function of the comparison result.

2. The method according to claim 1, further comprising the step of generating the imaging data, generating comprising:
irradiating at least one illumination pattern comprising a plurality of illumination features onto the object; and
receiving at least one first image comprising a spot pattern originating from the object in response to the irradiated illumination pattern at an optical sensor unit.

3. The method according to claim 1, further comprising:
irradiating the at least one illumination pattern through a translucent display unit; and/or
passing the at least one first image comprising the spot pattern through said translucent display unit prior to the step of receiving.

4. The method according to claim 1,
wherein the process of obtaining the imaging data further comprises irradiating illumination light onto the object and receiving reflected light from the object for obtaining a second image of the object.

5. The method according to claim 4, wherein the first image comprises spots having an increased brightness and the second image includes a two-dimensional image of the object; and wherein the step of determining includes:
extracting at least one patch/area/region/footprint of an associated beam profile of the first image including at least one spot having highest brightness among the spots; and
generating for said identified/extracted spot at least one feature vector; wherein the step of comparing includes:
comparing the generated at least one feature vector with a plurality of predetermined feature vectors being representative for a material property of the object.

6. The method according to claim 5, wherein the step of comparing the at least one feature vector with reference feature vectors comprises deploying a machine learned classifier.

7. The method according to claim 1, further comprising:
for a plurality of material objects, generating at least one reference feature vector for each material object, and classifying the generated at least one reference feature vector into a material and/or object/product category,
wherein generating the at least one reference feature vector.

8. The method according to claim 6, further including:
training a machine learning classifier based on the generated and classified plurality of reference vectors.

9. The method according to claim 1, further comprising:
detecting, by processing the imaging data, a security marker at the object being indicative of an authenticity and/or origin of the object;
recognizing, by processing the imaging data a contour of the object; and/or
generating an authenticity signal for the object as a function of the determined material property and information derived from the security marker and/or the determined material property and the contour of the object.

10. The method according to claim 9, further comprising at least one of the steps of:
displaying a visual image of the object on a display unit in a display device using the imaging data;
overlaying the visual image with a bounding box indicating the detected security marker at the object; and
generating a validation signal perceivable for a user if an authenticity signal is generated.

11. The method according to claim 1, further comprising:
generating contour image features from the image data;
comparing the contour image features with reference image features generated from reference objects; and
recognizing a contour of the object as a function of the comparison.

12. The method according to claim 11, wherein the material property of the object is determined as a function of the comparison result and the recognized contour.

13. A display device comprising:
a monochromatic light source configured to generate at least one illumination pattern comprising a plurality of illumination features;
an optical sensor unit configured to capture at least one first image comprising a spot pattern originating from an object and to generate imaging data associated with the object;
at least one processing unit configured:
to receive the imaging data;
to determine, by processing the received imaging data, at least one reflection feature corresponding to a spot in the first image,
to compare, by processing the at least one reflection feature, the spot pattern comprised in the first image with reference spot patterns for obtaining a comparison result; and
to determine a material property of the object as a function of the comparison result; and
an output unit configured to output the comparison result and/or the determined material property.

14. A display device, wherein a processing unit is configured to cause the display device to carry out the method steps according to claim 1.

15. The display device according to claim 13, comprising a secure enclave configured to carry out the process of comparing and of determining.

16. A method of using the display device according to claim 13, the method comprising using the display device for authenticating an object, the object being selected from the group consisting of a branded product, a luxury item, a bank note, a package, a document, a passport, an identity card, a spare part, and a food container.

17. A computer-readable medium storing computer program instructions, wherein the computer program instructions, when executed by a processing unit in a display device, cause the display device to perform operations comprising the method according to claim 1.

18. The method according to claim 1, further comprising the step of generating the imaging data, generating comprising:
irradiating at least one illumination pattern comprising a plurality of illumination features onto the object using coherent light from a monochromatic light source; and
receiving at least one first image comprising a spot pattern originating from the object in response to the irradiated illumination pattern at an optical sensor unit.

19. The method according to claim 5, wherein the step of comparing the at least one feature vector with reference feature vectors comprises deploying an artificial neural network.

20. A method of using the display device according to claim 13, the method comprising using the display device for authenticating an object, the object having a visible or invisible marker or badge attached.
